(19) United States
(12) Patent Application Publication
(10) Pub. No.: US 2017/0141938 A1
(43) Pub. Date: May 18, 2017

(54) High Performance PIM Cancellation With Feed Forward Structure

(71) Applicant: Futurewei Technologies, Inc., Plano, TX (US)

(72) Inventors: Weizhong Chen, Austin, TX (US); Junhong Nie, McKinney, TX (US)

(21) Appl. No.: 14/939,185

(22) Filed: Nov. 12, 2015

(51) Int. Cl. H04L 25/03; H04B 1/40; H04L 5/14

(52) U.S. Cl. CPC H04L 25/03821; H04L 5/14; H04B 1/40

(57) ABSTRACT

A full-duplex transceiver with passive inter-modulation (PIM) cancellation using a feedforward filtering structure is presented. The transceiver can comprise a duplexer, a transmitter, a receiver, a summer, and a behavioral model module (BMM) that is used to estimate an estimated inter-modulated signal using a feedforward structure. The summer receives a receive signal output from the receiver and a compensation signal, and output a PIM compensated receive signal based on the difference between the receive signal output and the compensation signal. Further, the BMM receives the multiband transmit signal input and the PIM compensated receive signal, where the BMM tunes the transceiver to output a PIM compensated receive signal. The BMM generates an estimated compensation signal from an align term, lag terms, and lead terms of the transmitted signals. The embodiments disclosed herein can be applicable to communication networks experiencing PIM distortion in a radio frequency chain.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Passive intermodulation (PIM) is the interfering signals caused by nonlinearities in the radio frequency (RF) transmission components of a wireless system. Two or more signals mix together to produce products of the two signals at their sum and difference of their respective frequencies. When the products fall into the band of the desired received signal, PIM interference can occur and cause distortions to the received signal.

PIM is a problem in almost any wireless system but is mostly noticeable in cellular base station antennas, transmission lines, and related components. PIM can occur for a variety of reasons. Such reasons can include the interaction of mechanical components generally causing the nonlinear elements, especially anywhere that two different metals come together. Junctions of dissimilar materials are a prime cause for PIM. PIM occurs in antenna elements, coax connectors, coax cable, and grounds. It can be caused by rust, corrosion, loose connections, dirt, oxidation, and any contamination of these factors. Even nearby metal objects such as guy wires and anchors, roof flashings, and pipes can cause PIM. The result is a diode-like nonlinearity that makes an excellent mixer. As nonlinearity increases, so does the amplitude of the PIM signals.

With respect to communication networks, PIM occurs due to the non-linear nature of passive components and has traditionally been a major concern when deploying cellular networks. Nonlinearities are present in components and interfaces due to material imperfections, and highlights the need for high-quality materials and finishes. For GSM networks, PIM is typically handled initially through non-duplexed equipment, which gives at least 30 dB isolation between receive chains and transmit chains.

In a typical duplex system, PIM distortion is handled through frequency planning and frequency hopping. For broadband systems such as Universal Terrestrial Radio Access (UTRA), that have limited radio frequency bandwidth, the lower order intermodulation products do not hit their own receive band and carriers have low power spectral density (PSD). For these reasons, the passive intermodulation does not contribute to any degradation of the receiver. The situation becomes different for wider radio frequency bandwidth in combination with high PSD carriers.

Additionally, though some prior art systems implement feed forward systems for cancelling PIM interference, these systems typically adjust for an aligned term but not for the lag and lead terms of the interference. Thus, there is a need for more accurate PIM distortion cancellation.

### SUMMARY

In various embodiments, the disclosure includes a full-duplex transceiver with PIM cancellation using feedforward filtering structure. The transceiver can comprise a duplexer, a transmitter, a receiver, a summer, and a behavioral model module (BMM). The duplexer is coupled to an antenna, where the duplexer is configured to direct an RF transmit signal to the antenna and an RF receive signal from the antenna. The transmitter can be configured to receive a multiband transmit signal input and provide the RF transmit signal to the duplexer. Further, the receiver can be configured to receive the RF receive signal from the duplexer and provide a receive signal output. In addition, the summer can be configured to receive the receive signal output from the receiver and a compensation signal, where the summer can be configured to output a PIM compensated receive signal based on the difference between the receive signal output and the compensation signal. Further, the BMM can be configured to receive the multiband transmit signal input and the PIM compensated receive signal, where the BMM tunes the transceiver to output a PIM compensated receive signal.

In accordance with various embodiments, the disclosure also includes the BMM generating an estimated compensation signal from an align term, lag terms, and lead terms of the transmitted signals. The embodiments disclosed herein can be applicable to 5G wireless networks, as well as any other communication network that may experience PIM distortion in a radio frequency chain.

In some embodiments, the disclosure also includes, alone or in combination with the above, the estimated compensation signal being generated using a complex envelope function defined by: F(x_{d1}, x_{d2})=c₀+c₁|x_{d1}|+c₂|x_{d2}|+c₃|x_{d1}|²+c₄|x_{d2}|²+c₅|x_{d1}||x_{d2}|, where c₀, c₁, c₂, c₃, c₄, and c₅ are coefficients derived adaptively from the PIM compensated signal.

In some embodiments, the disclosure also includes, alone or in combination with the above, the transceiver further comprises a filter coupled to the BMM and the summer, where the filter is a baseband filter paired with the receiver, and where the filter filters the BMM output signal to match a receive band.

In some embodiments, the disclosure also includes, alone or in combination with the above, the transmitter can comprise an up-converter and a power amplifier, where the transmitter is configured to move a central carrier frequency of the RF transmit signal. The receiver can comprise a down-converter, low noise amplifier, and an analog-to-digital converter, where the analog-to-digital converter converts the RF receive signal to the receive signal output in digital form.

In other various embodiments, the disclosure includes a PIM cancellation method in a full-duplex transceiver, the method comprising directing, by a duplexer coupled to an antenna, an RF transmit signal to the antenna and an RF receive signal from the antenna, receiving, by a transmitter, a multiband transmit signal input, providing, by the transmitter, the RF transmit signal to the duplexer, receiving, by a receiver, the RF receive signal from the duplexer, providing, by the receiver, a receive signal output, receiving, by a summer, the receive signal output from the receiver and a compensation signal, outputting, by the summer, a PIM compensated receive signal based on the difference between the receive signal output and the compensation signal, receiving, by a BMM, the multiband transmit signal input and the PIM compensated receive signal for obtaining c₀, c₁, c₂, c₃, c₄, and c₅ coefficients, and outputting, by the BMM, an estimated compensation signal.

In other various embodiments, the disclosure includes a behavior model module (BMM) in a transceiver, the BMM can comprise a memory and a processor coupled to the memory, wherein the memory includes instructions that when executed by the processor cause the BMM to perform the following: receive, by the BMM, a multiband transmit signal input and a PIM compensated receive signal, and output, by the BMM, an estimated compensation signal.

In some embodiments, the disclosure also includes, alone or in combination with the above, generating, by the BMM, the estimated compensation signal based on an align term, lag terms, and lead terms of the delayed PIM estimate signal.

In some embodiments, the disclosure also includes, alone or in combination with the above, generating the estimated compensation signal using a complex envelope function defined by F(x_{d1}, x_{d2})=c₀+c₁|x_{d1}|+c₂|x_{d2}|+c₃|x_{d1}|²+c₄|x_{d2}|²+c₅|x_{d1}||x_{d2}|, where c₀, c₁, c₂, c₃, c₄, and c₅ are coefficients derived adaptively from the PIM compensated signal.

In some embodiments, the disclosure also includes, alone or in combination with the above, estimated compensation signal y_{PIM}(n) can be defined by at least one of:

y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2); or

y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−1)|, |x_{d2}(n+2)|)x_{d1}²(n−1)x_{d2}*(n+2)+F(|x_{d1}(n−2)|, |x_{d2}(n−1)|)x_{d1}²(n−2)x_{d2}*(n+1); or

y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2); or

y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1).

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a transceiver with reduced PIM distortion;

FIG. 2 is a graphical representation of a delay coverage of a first PIM distortion reducing transceiver embodiment;

FIG. 3 is a graphical representation of a delay coverage of a second PIM distortion reducing transceiver embodiment;

FIG. 4 is a graphical representation of a delay coverage of a third PIM distortion reducing transceiver embodiment;

FIG. 5 is a schematic diagram of an embodiment of a base-station with reduced PIM distortion; and

FIG. 6 is a flowchart of an exemplary method of PIM cancellation.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure is described with respect to a PIM cancellation apparatus and method that may be implemented in various systems and for various purposes, including but not limited to: a base-station in a wireless network, a mobile terminal, a mobile device, or any other electronic or communication device having a receiver, a transmitter, and a multiplexer. Further, in the following embodiments, various operating parameters and components are described for one or more exemplary embodiments. The specific operating parameters and components are included as examples and are not meant to be limiting.

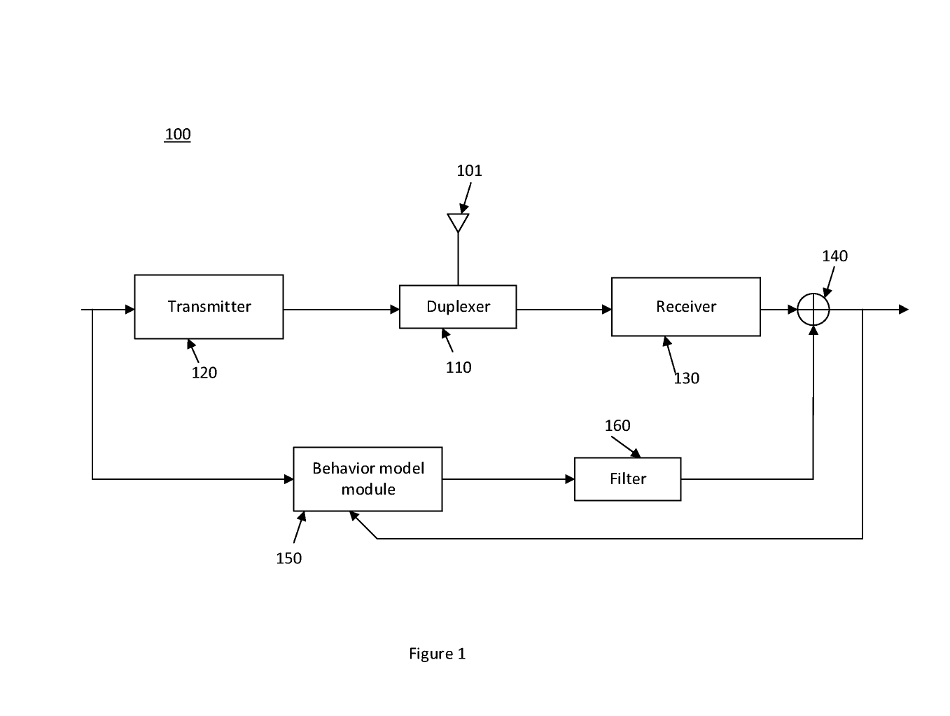

In accordance with various embodiments, a full-duplex transceiver can reduce PIM distortion in nonlinear circuits by implementing a feed-forward filtering structure. FIG. 1 is a schematic diagram of an embodiment of a transceiver with reduced PIM distortion. A full-duplex transceiver 100 can be designed to cancel or reduce PIM distortion, the transceiver 100 comprising a duplexer 110, a transmitter 120, a receiver 130, a summer 140, and a behavior model module (BMM) 150. Additionally, in various embodiments, the transceiver 100 further comprises a filter 160 connected between the BMM 150 and the summer 140.

The duplexer 110 is connected to an antenna 101 and operates in full-duplex operation. The duplexer 110 is configured to direct a RF transmit signal to the antenna and an RF receive signal from the antenna. Furthermore, the duplexer 100 is coupled to the transmitter 120 and the receiver 130. The transmitter 120 can be configured to receive a multiband transmit baseband signal input and provide the RF transmit signal to the duplexer 110. The receiver 120 can be configured to receive the RF receive signal from the duplexer 110 and provide a receive signal output. In turn, the summer 140 can be configured to receive the receive signal output from the receiver 130 and an estimated compensation signal. The summer 140 is configured to output a PIM compensated receive signal based on the difference between the receive signal output and the estimated compensation signal.

Furthermore, in various embodiments, the transmitter 120 can comprise an up-converter and a power amplifier. The transmitter is configured to move the central carrier frequency of the multiband transmit baseband signal input to meet the transmission bandwidth and frequency of the RF transmit signal. Moreover, in various embodiments, the receiver 130 can comprise a down-converter, low noise amplifier, and an analog-to-digital converter. The analog-to-digital convertor converts the RF receive signal to the receive signal output in digital form before providing to the summer 140.

The filter 160 receives an output signal from the BMM 150, filters the BMM output signal that falls within a receive band, and provides the estimated compensation signal to the summer 140. The filter 160 can be a baseband filter that is paired with the receiver bandwidth.

In accordance with various embodiments, the BMM 150 can be configured to receive the multiband transmit signal input when operating in normal operation model and the PIM compensated receive signal when adjusting the BMM model parameters. The BMM 150 can comprise a processor. The processor can comprise one or more multi-core processors and/or memory devices, which may function as data stores, buffers, etc. The processor may be implemented as a general processor or may be part of one or more application specific integrated circuits (ASICs), field programmable gate array (FPGA), and/or digital signal processors (DSPs). Moreover, the BMM 150 can be configured to generate a compensation signal that estimates the PIM distortion of the receive signal. For example, the BMM 150 tunes the transceiver to output a PIM compensated receive signal based on the two inputs. As previously mentioned, the inter-modulation of two transmit signals through the antenna and duplexer can result in PIM distortion of the receive signal where the inter-modulated signal may fall into the receive band and cause interference. The receiver 130 receives the receive signal mixed with the interference signal. The interference can degrade the receiver sensitivity due to the resulting noise increase, thereby impacting receiver performance. Interference signals are normally isolated using a filter, however a filter may not work when transmit band and receive band are too close and not sufficiently separated to filter, such as in 5G communications.

In various embodiments, the PIM distortion cancellation is generated by estimating the PIM interference and subtracts the PIM estimate signal from the received signal. The BMM 150 tunes for the PIM distortion by adjusting delay parameters including an align term, lag terms, and lead terms of the transmitted signals.

The basis for the estimated delay parameters can be a generic non-linearity algorithm, such as a Volterra Series Model. However, the non-linearity algorithm can be simplified using basic assumptions for specific implementation. The simplification can be to limit the number of possible terms in estimating the PIM interference. The interference in a receive signal at time zero can also have a distorting affect both a priori and a posteriori. Therefore a detailed estimate of the PIM interference would calculate the distortion at numerous time offsets (e.g., an offset range of ±10 time periods or more). However, in various embodiments of this disclosure, not every offset point is determined. The efficiency of determining the estimated compensation signal can be increased by not summing each and every possible term within a range.

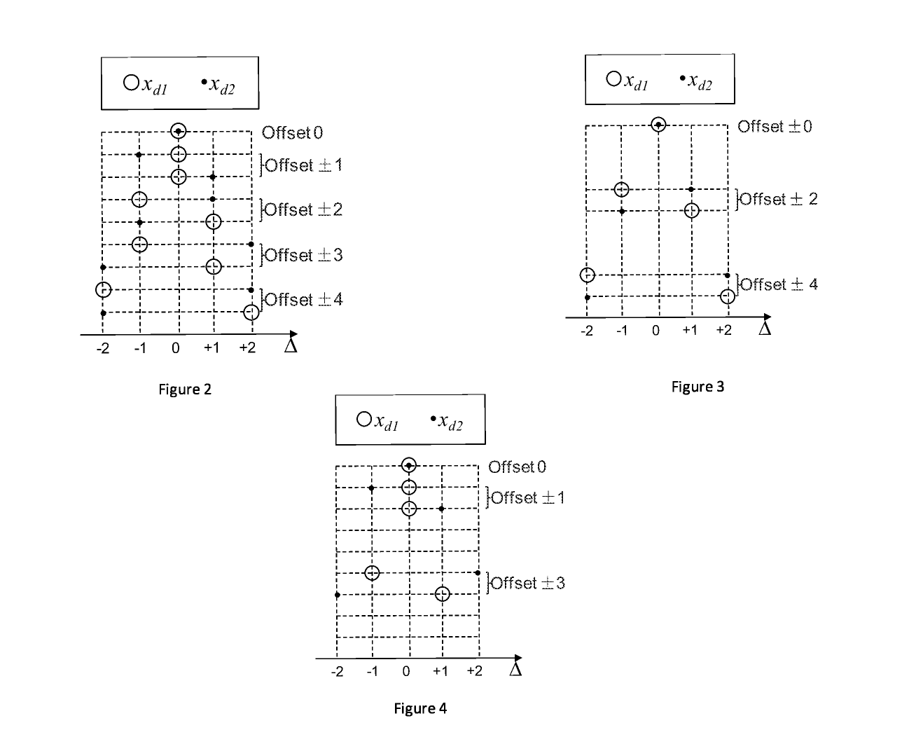

A reduced number of nonlinear components can be used in parameter calculations to produce results with sufficient accuracy. For example, between 5/25 to 9/25 of complexity, defined as reduced number over total possible number, as shown in FIG. 2, FIG. 3, and FIG. 4 can obtain the sufficient accuracy, for example within 1 dB of a cancellation target, such as 20 dB. In accordance with various embodiments, the estimated compensation terms can be calculated using various offsets between the two input signals (transmit signals x_{d1} and x_{d2}). Various combinations of the offset values may be used for determining the estimated compensation signal. The offset ranges can be ±1, ±2, ±3, ±4, or any combination thereof. For example, FIG. 2 illustrates a graphical representation of offset ranges of ±1, ±2, ±3, and ±4; FIG. 3 illustrates a graphical representation of offset ranges of ±2 and ±4; and FIG. 4 illustrates a graphical representation of offset ranges of ±1 and ±3.

In accordance with various embodiments, a complex envelope function F of transmit signals x_{d1} and x_{d2} can be determined by a number of delay parameters using coefficients c₀, c₁, c₂, c₃, c₄, and c₅. The coefficients are derived from the PIM compensate signal in the receive chain feedback and an adaptive filtering algorithm, for example least mean squared (LMS) adaptive algorithm. In a first embodiment, the complex envelope F is determined by:

F(x_{d1}, x_{d2})=c₀+c₁|x_{d1}|²+c₂|x_{d2}|²+c₃|x_{d1}|⁴+c₄|x_{d2}|⁴+c₅|x_{d1}|²|x_{d2}|²

In a second embodiment, the complex envelope function F of transmit signals x_{d1} and x_{d2} is determined by:

F(x_{d1}, x_{d2})=c₀+c₁|x_{d1}|²+c₂|x_{d2}|²+c₃|x_{d1}|²+c₄|x_{d2}|²+c₅|x_{d1}||x_{d2}|

The complex envelope function can be applied to align, lag, and lead terms in order to tune the parameters at the behavior module. In accordance with various embodiments and with reference to FIG. 2, the feedforward adjustment/estimated interference signal y_{PIM}(n) is based on offsets of 0, ±1, ±2, ±3, and ±4 as described by the following equation:

y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n)x_{d2}*(n−1)+F(|x_{d1}(n)|, |x_{d2}(n+1)|)x_{d1}²(n)x_{d2}*(n+1)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2).

The above equation has the align term and four offset values, resulting in nine terms of six parameters each, thus a total of 54 parameters in the calculation.

The processing complexity can be reduced without sacrificing much accuracy, such as within 1 dB of the cancellation target, such as such 20 dB. For example, instead of calculating every position associated with offset of 0, ±1, ±2, ±3, and ±4, the estimate can be based on a reduced number of offsets. By way of example, there may be the align term and only two offset values. The equation would comprise five terms of six parameters each, and thus a total of 30 parameters to calculate. Specifically, the estimated interference signal y_{PIM}(n) equation can be based on offsets of ±2 and ±4, yielding:

y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2).

In another embodiment, the estimated interference signal y_{PIM}(n) equation can be based on offsets of ±1 and ±3, yielding:

y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−1)|, |x_{d2}(n+2)|)x_{d1}²(n−1)x_{d2}*(n+2)+F(|x_{d1}(n−2)|, |x_{d2}(n−1)|)x_{d1}²(n−2)x_{d2}*(n+1).

In another embodiment, the estimated interference signal y_{PIM}(n) equation can be based on offsets of ±1 and ±4, yielding:

y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2).

In another embodiment, the estimated interference signal y_{PIM}(n) equation can be based on offsets of ±2 and ±3, yielding:

y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1).

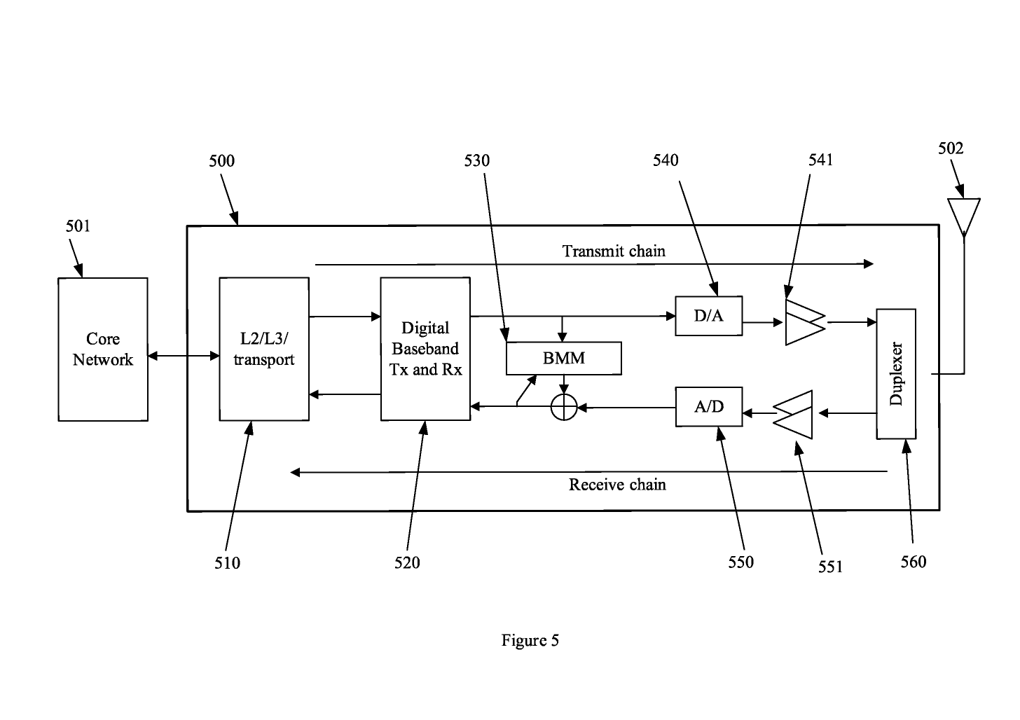

Applications of the disclosed embodiments can include communication systems implementing a 5th Generation (5G) wireless communication system. Disclosed embodiments may be applicable to any system with a transmit band and a receive band operating close enough to cause PIM interference. By way of example, the feedforward PIM cancellation device and method as described above can be implemented in a base station of a communication system. In various embodiments and with reference to FIG. 5, a wireless base-station 500 can comprise a transport layer 510, a digital baseband transceiver 520, a behavioral model module 530, a digital-to-analog converter 540, one or more power amplifiers 541, a duplexer 560, an analog-to-digital converter 550, and one or more low noise amplifiers 551. The transport layer 510 may be in communication with a core network 501. The duplexer can be coupled to an antenna 502. As disclosed herein, the base-station 500 can be configured to communicate signals in a 5th generation network as defined by Next Generation Mobile Networks (NGMN) Alliance.

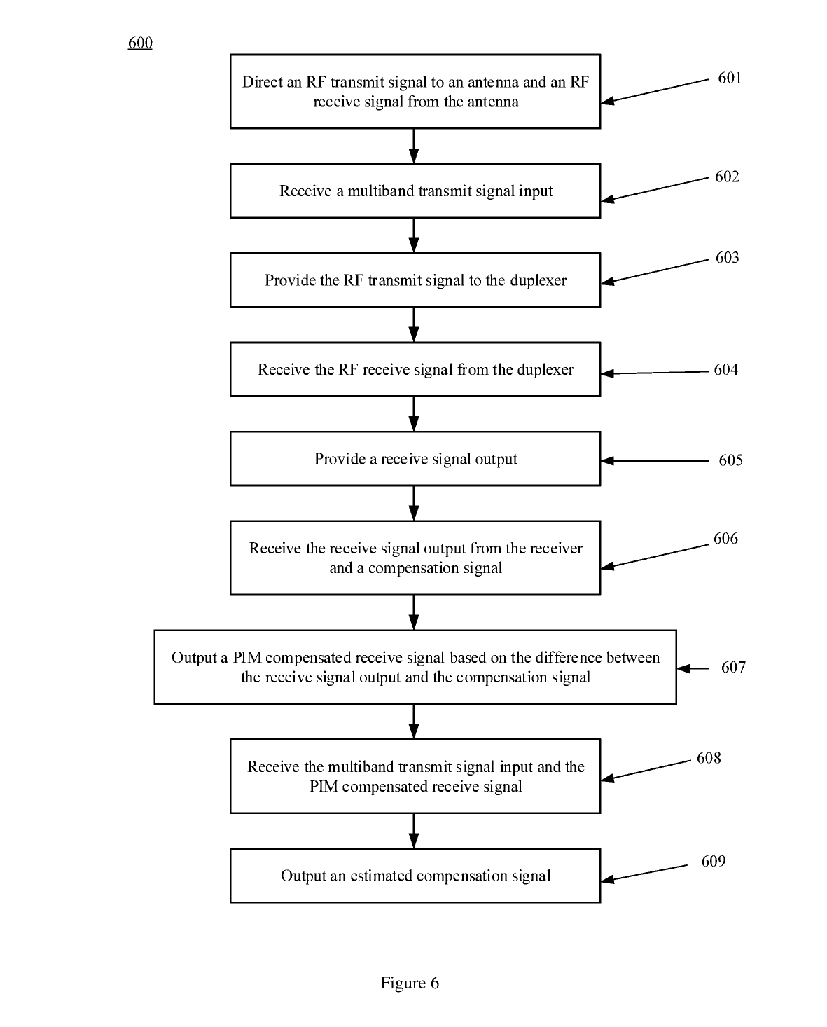

In accordance with various embodiments and with reference to FIG. 6, a PIM cancellation method 600 in a full-duplex transceiver can comprise directing, by a duplexer coupled to an antenna, an RF transmit signal to the antenna and an RF receive signal from the antenna 601, and receiving, by a transmitter, a multiband transmit signal input 602. The transmitter provides the RF transmit signal to the duplexer 603. The method 600 further comprises receiving, by a receiver, the RF receive signal from the duplexer 604, and providing, by the receiver, a receive signal output 605. Moreover, the method 600 further comprises receiving, by a summer, the receive signal output from the receiver and a compensation signal 606, outputting, by the summer, a PIM compensated receive signal based on the difference between the receive signal output and the compensation signal 607, receiving, by a BMM, the multiband transmit signal input and the PIM compensated receive signal 608, and outputting, by the BMM, an estimated compensation signal 609. Additionally, the method 600 can further comprise generating, by the BMM, the estimated compensation signal based on an align term, lag terms, and lead terms of the multiband transmit signal input.

It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hard wires the instructions of the software. In the same manner as a machine controlled by a new ASIC is a particular machine or apparatus, likewise a computer that has been programmed and/or loaded with executable instructions may be viewed as a particular machine or apparatus.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A full-duplex transceiver with passive inter-modulation (PIM) cancellation, the transceiver comprising:
a duplexer coupled to an antenna, wherein the duplexer is configured to direct a radio frequency (RF) transmit signal to the antenna and an RF receive signal from the antenna;
a transmitter configured to receive a multiband transmit signal input and provide the RF transmit signal to the duplexer;
a receiver configured to receive the RF receive signal from the duplexer and provide a receive signal output;
a summer configured to receive the receive signal output from the receiver and a compensation signal, wherein the summer is configured to output a PIM compensated receive signal based on the difference between the receive signal output and the compensation signal; and
a behavior model module (BMM) configured to receive the multiband transmit signal input and the PIM compensated receive signal, wherein the BMM tunes the transceiver to output a PIM compensated receive signal.

2. The transceiver of claim 1, wherein the BMM generates an estimated compensation signal based on an align term, lag terms, and lead terms of the multiband transmit signal input.

3. The transceiver of claim 2, wherein the estimated compensation signal is generated using a complex envelope function defined by:
F(x_{d1}, x_{d2})=c₀+c₁|x_{d1}|+c₂|x_{d2}|+c₃|x_{d1}|²+c₄|x_{d2}|²+c₅|x_{d1}||x_{d2}|,
wherein c₀, c₁, c₂, c₃, c₄, and c₅ are coefficients adaptively derived from the PIM compensated receive signal, and wherein x_{d1} and x_{d2} are transmit signals.

4. The transceiver of claim 2, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2),
wherein x_{d1} and x_{d2} are transmit signals.

5. The transceiver of claim 2, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−1)|, |x_{d2}(n+2)|)x_{d1}²(n−1)x_{d2}*(n+2)+F(|x_{d1}(n−2)|, |x_{d2}(n−1)|)x_{d1}²(n−2)x_{d2}*(n+1),
wherein x_{d1} and x_{d2} are transmit signals.

6. The transceiver of claim 2, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2),
wherein x_{d1} and x_{d2} are transmit signals.

7. The transceiver of claim 2, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1),
wherein x_{d1} and x_{d2} are transmit signals.

8. The transceiver of claim 1, further comprising a filter coupled to the BMM and the summer, wherein the filter is a baseband filter paired with the receiver, and wherein the filter filters the BMM output signal to match a receive band.

9. The transceiver of claim 1, wherein the transmitter comprises an up-converter and a power amplifier, and wherein the transmitter is configured to move a central carrier frequency of the RF transmit signal.

10. The transceiver of claim 1, wherein the receiver comprises a down-converter, low noise amplifier, and an analog-to-digital converter, wherein the analog-to-digital converter converts the RF receive signal to the receive signal output in digital form.

11. The transceiver of claim 1, wherein the transceiver communicates signals in a 5th generation network as defined by Next Generation Mobile Networks (NGMN) Alliance.

12. A passive inter-modulation (PIM) cancellation method in a full-duplex transceiver, the method comprising:
directing, by a duplexer coupled to an antenna, a radio frequency (RF) transmit signal to the antenna and an RF receive signal from the antenna;
receiving, by a transmitter, a multiband transmit signal input;
providing, by the transmitter, the RF transmit signal to the duplexer;
receiving, by a receiver, the RF receive signal from the duplexer;
providing, by the receiver, a receive signal output;
receiving, by a summer, the receive signal output from the receiver and a compensation signal;
outputting, by the summer, a PIM compensated receive signal based on the difference between the receive signal output and the compensation signal;
receiving, by a behavior model module (BMM), the multiband transmit signal input and the PIM compensated receive signal; and
outputting, by the BMM, an estimated compensation signal.

13. The method of claim 12, further comprising generating, by the BMM, the estimated compensation signal based on an align term, lag terms, and lead terms of the multiband transmit signal input.

14. The method of claim 13, further comprising generating the estimated compensation signal using a complex envelope function defined by:
F(x_{d1}, x_{d2})=c₀+c₁|x_{d1}|+c₂|x_{d2}|+c₃|x_{d1}|²+c₄|x_{d2}|²+c₅|x_{d1}||x_{d2}|,
wherein c₀, c₁, c₂, c₃, c₄, and c₅ are coefficients adaptively derived from the PIM compensated receive signal, and wherein x_{d1} and x_{d2} are transmit signals.

15. The method of claim 13, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2),
wherein x_{d1} and x_{d2} are transmit signals.

16. The method of claim 13, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−1)|, |x_{d2}(n+2)|)x_{d1}²(n−1)x_{d2}*(n+2)+F(|x_{d1}(n−2)|, |x_{d2}(n−1)|)x_{d1}²(n−2)x_{d2}*(n+1),
wherein x_{d1} and x_{d2} are transmit signals.

17. The method of claim 13, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2),
wherein x_{d1} and x_{d2} are transmit signals.

18. The method of claim 13, wherein the estimated compensation signal y_{PIM}(n) is defined by:
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1),
wherein x_{d1} and x_{d2} are transmit signals.

19. A behavior model module (BMM) in a transceiver, the BMM comprising:
a memory; and
a processor coupled to the memory, wherein the memory includes instructions that when executed by the processor cause the BMM to perform the following:
receive, by the BMM, a multiband transmit signal input and a PIM compensated receive signal; and
output, by the BMM, an estimated compensation signal, wherein the estimated compensation signal y_{PIM}(n) is defined by at least one of:
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2); or
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−1)|, |x_{d2}(n+2)|)x_{d1}²(n−1)x_{d2}*(n+2)+F(|x_{d1}(n−2)|, |x_{d2}(n−1)|)x_{d1}²(n−2)x_{d2}*(n+1); or
y_{PIM}(n)=F(|x_{d1}(n)|, |x_{d2}(n)|)x_{d1}²(n)x_{d2}*(n)+F(|x_{d1}(n)|, |x_{d2}(n−1)|)x_{d1}²(n−1)x_{d2}*(n−1)+F(|x_{d1}(n)|, |x_{d2}(n+1)|)x_{d1}²(n+1)x_{d2}*(n+1)+F(|x_{d1}(n−2)|, |x_{d2}(n+2)|)x_{d1}²(n−2)x_{d2}*(n+2)+F(|x_{d1}(n+2)|, |x_{d2}(n−2)|)x_{d1}²(n+2)x_{d2}*(n−2); or
y_{PIM}(n)=F(|x_{d1}(n)|, |x_{d2}(n)|)x_{d1}²(n)x_{d2}*(n)+F(|x_{d1}(n−1)|, |x_{d2}(n+1)|)x_{d1}²(n−1)x_{d2}*(n+1)+F(|x_{d1}(n+1)|, |x_{d2}(n−1)|)x_{d1}²(n+1)x_{d2}*(n−1)+F(|x_{d1}(n−1)|, |x_{d2}(n+2)|)x_{d1}²(n−1)x_{d2}*(n+2)+F(|x_{d1}(n−2)|, |x_{d2}(n+1)|)x_{d1}²(n−2)x_{d2}*(n+1),
wherein x_{d1} and x_{d2} are transmit signals.

20. The BMM of claim 19, wherein the PIM estimate signal is generated using a complex envelope function defined by:
F(x_{d1}, x_{d2})=c₀+c₁|x_{d1}|+c₂|x_{d2}|+c₃|x_{d1}|²+c₄|x_{d2}|²+c₅|x_{d1}||x_{d2}|,
wherein c₀, c₁, c₂, c₃, c₄, and c₅ are coefficients adaptively derived from the PIM compensated receive signal.
